(19) United States
(12) Patent Application Publication
(10) Pub. No.: US 2007/0135090 A1
(43) Pub. Date: Jun. 14, 2007

(54) Location determination warning

(76) Inventors: Ronald Bruce Martin, Carol Stream, IL (US); Randall Joe Wilson, Duluth, GA (US)

Correspondence Address: Werner Ulrich, 434 Maple Street, Glen Ellyn, IL, 60137, US

(21) Appl. No.: 11/297,943

(22) Filed: Dec. 8, 2005

(51) Int. Cl. H04M 11/04

(52) U.S. Cl. 455/404.2

(57) ABSTRACT

This invention relates to a method and apparatus for warning telephone and wireless customers of a localized emergency condition such as a tornado. The agency responsible for such notification sends a message to an emergency transmission unit. This unit will then cause a warning to be sent to all cellular stations in a plurality of cells defined by the notification message. A similar warning can be sent to land-based stations in the geographic area defined by these cells. Advantageously, the telephone and wireless customers of the affected area can be warned quickly.

### TECHNICAL FIELD

This invention relates to warnings of local conditions, such as tornados, to mobile telecommunications stations.

### BACKGROUND OF THE INVENTION

For many emergency conditions, such as tornados or derailment of a railway car carrying poisonous substances, it is important that all people in an affected area be notified as soon as possible so that they may escape the harmful effects of the condition. While current warning schemes broadcast in a wide area may have the desired effect for some people, the sense of urgency is sharply increased by a more targeted warning system. In addition, if an individual is traveling, that individual may not be familiar with the names of local towns or counties and may therefore not be certain whether a warning applies to him/her.

### SUMMARY OF THE INVENTION

The above problem is considerably alleviated especially for cellular customers in accordance with this invention wherein all cellular customers, who are currently in an area defined by a plurality of cellular cells and who have their mobile stations powered on, are directly notified of the presence of the dangerous condition; an emergency warning system queries the cellular location database to identify mobiles that are currently in one of an identified group of cells and sends warning messages to these mobile stations.

In accordance with one preferred embodiment the emergency management system comprising a server connected to the telecommunications system serving these customers, queries the cellular system location database, such as the home location register and visitor location register, for the affected areas and identifies those mobile stations which are registered in one of the cells identified as the area in danger. Other location arrangements include but are not limited to a query of the cellular station's global positioning system or triangulation arrangements for locating a cellular station from directional signals received at two or more cell sites. The emergency management system then transmits voice or data messages as appropriate, to the particular cellular stations through the mobile switching center for communicating with the cell sites which communicate with the cellular stations. These cell sites then transmit a message or voice announcement to the affected mobile stations to warn the user of the mobile station of the emergency. If the affected mobile station has call waiting, an identification of the emergency management system as the caller would alert that station that a critical call is being sent.

In accordance with another aspect of Applicants' invention, the same general approach can be used to warn land line telephone users of the emergency. A database which can be stored in the emergency management system would contain all telephone numbers of stations on a per cell basis so that these telephones could be identified and telephone messages sent to the customers owning these land line stations. Alternate databases, such as databases containing all active units on a per office code basis, can also be used to identify the affected telephone stations.

In accordance with one feature of the invention, the location warning messages can be triggered for an identified cell or group of cells by government personnel or other emergency personnel. For example, the same emergency trigger can be used for triggering warning sirens or telephone announcements,

In accordance with one feature of Applicants' invention, such specialized announcements can be highlighted by a specialized ring and/or a specialized call identification in order to properly alert the customer of the seriousness of the message being sent.

### BRIEF DESCRIPTION OF THE DRAWINGS

FIG. 1 is a block diagram illustrating the operation of Applicants' invention;

FIG. 2 is a flow diagram illustrating the operation of Applicants' invention;

FIG. 3 is a block diagram of the operation of Applicants' invention when applied to land line telecommunications stations; and

FIG. 4 is a flow diagram illustrating the operation of Applicants' invention for land-based telephone stations.

### DETAILED DESCRIPTION

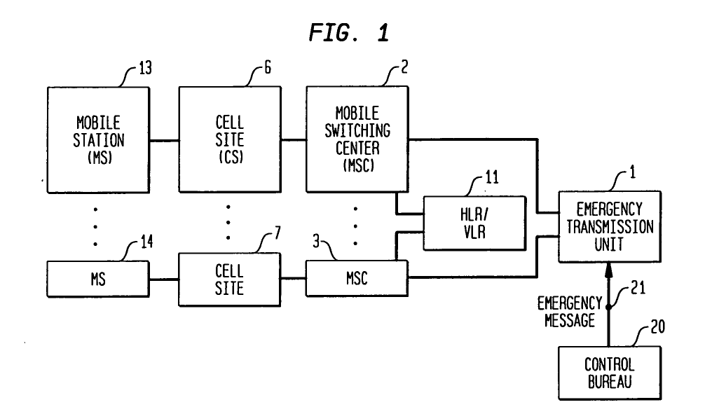

FIG. 1 is a block diagram illustrating the operation of Applicants' invention. An emergency transmission unit 1, a server connected to the telecommunications system serving the cellular system customers, serves as the source of messages for warning the cellular system customers of an emergency condition. The emergency transmission unit is controlled by government agencies such as the National Weather Service Center or local government agencies such as police departments via an emergency message 21 from a control bureau 20. The emergency message identifies the area to be warned. The area can be identified in the message, or the message can provide a key from which the emergency transmission unit can identify the cells of the area to be warned. These government agencies identify a geographic area within which mobile stations should be warned. The emergency transmission unit translates these local indications into the identification of a group of cell sites which cover this geographic area. The emergency transmission unit then queries the location database, usually a combination of visitor location resisters and home location registers, to identify all the mobile stations that are currently in the area served by the identified cell sites. Alternatively, the emergency transmission unit can send a request to the mobile switching centers 2, . . . ,3 to have them request information from their home location registers and visitor location registers to identify the mobile stations which should be warned. The emergency transmission unit then causes the mobile switching centers to set up connections via cell sites 6, . . . ,7 to mobile stations 13, . . . ,14. If the mobile switching centers have broadcast capabilities, these capabilities can be used to address multiple mobile stations simultaneously.

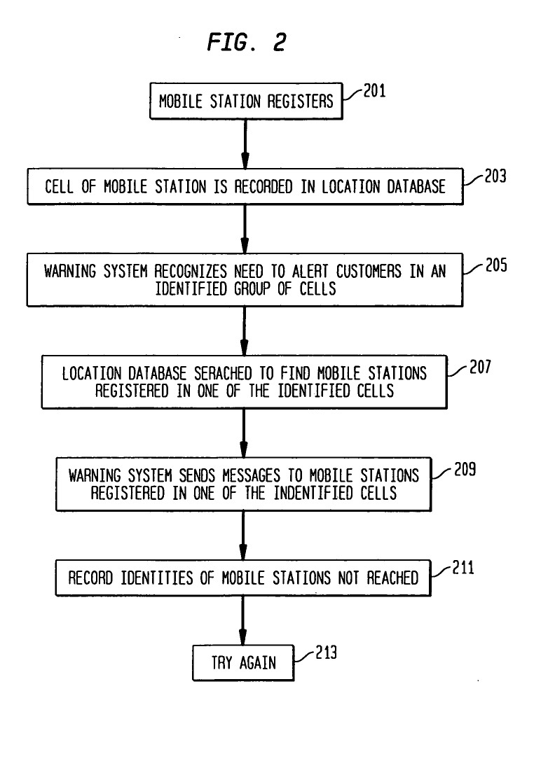

FIG. 2 is a flow diagram illustrating the operation of Applicants' invention. As part of its normal process, a mobile station registers in the system, thereby identifying its location (action block 201). The registration process causes the location database to store the identity of the cell in which the mobile station is located (action block 203). At some later time, the warning system recognizes the need to alert customers in an identified group of cells (action block 205). The warning system operators identify the geographic area to be covered and the warning system has stored for each geographic area a list of cells in that area. The location database is then searched to find the identities of mobile stations registered in one of the identified cells (action block 207). The warning system then sends messages to all mobile stations registered in one of the identified cells (action block 209). As discussed above, these messages may be voice messages or data messages depending on the type of device of each mobile station. Further, the warning system may cause a single message to lead to a broadcast message from a mobile switching center. The mobile switching centers record the identities of mobile stations not reached and if appropriate reports these identities to the warning system (action block 211). For those mobile stations which have not been reached another attempt is made (action block 213).

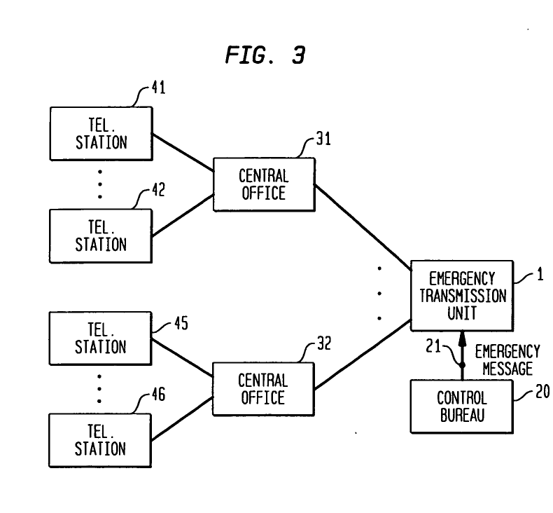

FIG. 3 illustrates the operation of Applicants' invention as applied to land-based telephone stations. The emergency transmission unit 1, connected to a control bureau 20, and receiving an emergency message 21, identifies which central offices 31, . . . ,32 serve telephone stations in the affected area. In the example shown in FIG. 3, central office 31 serves telephone stations 41, . . . ,42 in the affected area and central office 32 serves telephone stations 45, . . . ,46 located in the affected area. The emergency transmission unit then sends messages to the central offices 31 and 32 for distribution to telephone stations 41, . . . ,42 and 45, . . . ,56 respectively. If the central offices are equipped with broadcast facilities, these central offices may send messages simultaneously to several or all of the telephone stations that are in the affected area. Otherwise, the messages are sent one at a time.

Both the central office 31 and 32 and the mobile switching centers 2, . . . ,3 (FIG. 1) are equipped with voice mail capabilities. If the telephone or mobile stations in the affected areas are not available, then individual voice mail messages can be left for these unavailable stations. The stations will then receive the voice mail as soon as they become active, i.e., powered on for mobile stations, off-hook for land-based stations.

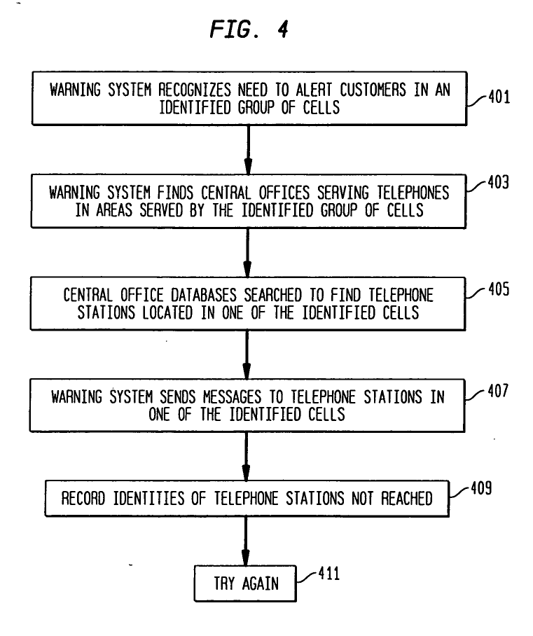

FIG. 4 is a flow diagram illustrating the operation of Applicants' invention in land-based stations. Again, the warning system recognizes the need to alert customers in an identified group of cells (action block 401). While it is possible to have a different geographic algorithm for land-based stations as opposed to mobile stations, the cellular identity is probably as good as any for sub-dividing an area into local entities. Clearly, it is also possible to have the warning system recognize the need to alert customers in one of the pre-specified group of geographic locations and to use these geographic locations for the purpose of alerting land-based stations.

The warning system then finds the identity of central offices serving telephones in areas served by the identified group of cells or, alternatively, within the appropriate group of geographic areas (action block 403). The central office databases are searched to find telephone stations located in one of the identified cells or one of the identified geographic locations (action block 405). Alternatively, for the case of land-based stations, it is possible to equip the emergency transmission unit with the telephone numbers of the stations in each cell or geographic area and to have the warning system find the telephone numbers of the telephone stations located in one of the identified cells or geographic areas. The warning system then sends messages to telephone stations in one of the identified cells or identified geographic areas (action block 407). Identities of telephone stations not reached are recorded (action block 409) and an attempt is made to try again (action block 411). In addition, it is possible to store a voice message in a voice messaging system of a serving central office.

The above description is of one preferred embodiment of Applicants' invention. Other embodiments will be apparent to those of ordinary skill in the art. The invention is limited only by the attached claims.

We claim:

1. Apparatus for warning telecommunications users in an identified area of an emergency condition, comprising:
an emergency transmission unit for accepting commands to send emergency messages to telecommunications stations in a specified geographic area; and
means, responsive to signals from said emergency transmission unit, for transmitting emergency messages to all telecommunications stations located in the specified area.

2. The apparatus of claim 1 further comprising:
a database for storing mobile cell sites of a plurality of mobile stations;
wherein said specified area comprises a plurality of mobile telecommunications cell sites and wherein mobile stations located in said area are found in said database.

3. The apparatus of claim 2 wherein mobile switching centers access said database in order to identify mobile stations currently registered in said cell sites.

4. The apparatus of claim 1 wherein said telecommunications stations are land line telecommunications stations served from central offices.

5. The apparatus of claim 4 wherein said emergency transmission unit identifies central offices serving said geographic area.

6. The apparatus of claim 5 wherein said central offices comprise data for identifying land-based telecommunications stations within said geographic area and wherein said central offices pass said emergency messages to said identified telecommunications stations.

7. The apparatus of claim 5 wherein said emergency transmission unit identifies telephone stations found in said geographic area.

8. A method for warning telecommunications users in an identified area of an emergency condition, comprising the steps of:
in an emergency transmission unit, receiving commands to send emergency messages to telecommunications stations in a specified geographic area and generating signals for requesting transmission of emergency messages; and
responsive to receipt of said signals from said emergency transmission unit, transmitting emergency messages to ail telecommunications stations located in the specified area.

9. The method of claim 8 further comprising the steps of:
storing mobile cell sites of a plurality of mobile stations in a database; and
finding mobile stations located in said area are in said database;
wherein said specified area comprises a plurality of mobile telecommunications cell sites.

10. The method of claim 9, further comprising the step of:
mobile switching centers accessing said database in order to identify mobile stations currently registered in said cell sites.

11. The method of claim 8 wherein said telecommunications stations are land line telecommunications stations served from central offices.

12. The method of claim 11, further comprising the step of:
said emergency transmission unit identifying central offices serving said geographic area.

13. The method of claim 12 wherein said central offices comprise data for identifying land-based telecommunications stations within said geographic area, further comprising the step of:
said central offices passing said emergency messages to said identified telecommunications stations.

14. The method of claim 12, further comprising the step of:
said emergency transmission unit identifying land-based telephone stations found in said geographic area.
